(19) United States
(12) Patent Application Publication
(10) Pub. No.: US 2017/0219836 A1
(43) Pub. Date: Aug. 3, 2017

(54) PARALLAX BARRIER PANEL AND DISPLAY DEVICE USING PARALLAX BARRIER PANEL

(71) Applicant: Japan Display Inc., Tokyo (JP)

(72) Inventors: Yosuke HYODO, Tokyo (JP); Shinichiro OKA, Tokyo (JP)

(21) Appl. No.: 15/391,446

(22) Filed: Dec. 27, 2016

(30) Foreign Application Priority Data
Feb. 3, 2016 (JP) 2016-018696

(51) Int. Cl. G02B 27/22; G02F 1/133; G02F 1/29; G02F 1/1343

(52) U.S. Cl. CPC G02B 27/2214; G02F 1/134309; G02F 1/13306; G02F 1/13439; G02F 1/29

(57) ABSTRACT

A parallax barrier panel including a first substrate, a second substrate opposing the first substrate, a liquid crystal layer between the first substrate and the second substrate, a plurality of first electrodes arranged between the first substrate and the liquid crystal layer, the plurality of first electrodes extending in a first direction, a plurality of second electrodes arranged between the plurality of first electrodes and the liquid crystal layer, the plurality of second electrodes extending in the first direction and arranged alternating with the plurality of first electrodes in a planar view, and an opposing electrode opposing the plurality of first electrodes and the plurality of second electrodes, wherein the second electrode is insulated from the first electrode, and a width of the second electrode in the second direction intersecting the first direction is smaller than a width of the first electrode in the second direction.

### CROSS REFERENCE TO RELATED APPLICATIONS

This application is based upon and claims the benefit of priority from the prior Japanese Patent Application No. 2016-018696, filed on Feb. 3, 2016, the entire contents of which are incorporated herein by reference.

### FIELD

The present invention is related to a parallax barrier panel, a driving method of a parallax barrier panel, and a display device using the parallax barrier panel. In particular, the present invention is related to a parallax barrier panel using a liquid crystal, a driving method of a parallax barrier panel, and a display device using the parallax barrier panel.

### BACKGROUND

In recent years, in addition to display devices which display two-dimensional images (2D image), development of a display device for displaying a three-dimensional image (3D image) is advancing. A 3D display device for displaying a 3D image has a configuration for provide an image for the left eye to the left eye of a viewer (user) and an image for the right eye to the right eye of the user. Different images are each provided for the image for the left eye and the image for the right eye respectively. A user can obtain a 3D image by a slight shift (parallax) in a left-right direction between an image viewed by the user's right eye and an image viewed by the user's left eye.

A parallax barrier method and lenticular method are generally known as a method for providing parallax described above to a user. In the parallax barrier method, a barrier is arranged between a user and a display device so that only an image for the right eye is viewed by the user's right eye and only the image for the left eye is viewed by the user's left eye. The barrier used for the parallax barrier method is called a parallax barrier. In the parallax barrier method, since an image displayed on a display device using a parallax barrier is viewed only by the user's right eye or left eye, dedicated glasses for viewing 3D images are unnecessary. In particular, by using liquid crystals in the parallax barrier, since the position of the barrier can be controlled corresponding to the position of the eye of the user, it has an advantage that the position of the eye of the user can be tracked and a 3D image can be provided to the user from any position. Furthermore, by using liquid crystals in the parallax barrier, there is an advantage that a 2D image and a 3D image can be easily switched. In the present specification, parallax barrier may be omitted and may be simply referred to as “barrier”.

In the case of a parallax barrier using liquid crystals, it is necessary to arrange an electrode for controlling liquid crystals in a parallax barrier panel (hereinafter sometimes referred to simply as “barrier panel”) in order to control the orientation of the liquid crystals. In order to track the position of the eyes of a user and control the barrier position, it is necessary to control a plurality of liquid crystal control electrodes mutually independently of each other. Therefore, it was necessary to arrange a space between the plurality of liquid crystal control electrodes.

In order to control the liquid crystal at a position corresponding to the space described above, in Japanese Laid Open Patent Application Publication No. 2015-099202 for example, two electrodes for liquid crystal control are arranged, a second electrode for liquid crystal control on an upper layer (hereinafter, second electrode) is arranged at a position corresponding to the space of a first electrode for liquid crystal control on a lower layer (hereinafter, first electrode).

However, in the case of a barrier panel in which two layers of liquid crystal control electrodes are arranged as described above, since the distance from an opposing counter electrode to the first electrode of the lower layer is longer than the distance from the opposing counter electrode to the second electrode of the upper layer, an electric field shape generated by the first electrode and an electric field shape generated by the second electrode are different. Due to this, there is a problem that the shape of a barrier region formed by the first electrode is different from the shape of a barrier region formed by the second electrode.

### SUMMARY

A parallax barrier panel according to one embodiment of the present invention includes a first substrate, a second substrate opposing the first substrate, a liquid crystal layer between the first substrate and the second substrate, a plurality of first electrodes arranged between the first substrate and the liquid crystal layer, the plurality of first electrodes extending in a first direction, a plurality of second electrodes arranged between the plurality of first electrodes and the liquid crystal layer, the plurality of second electrodes extending in the first direction and arranged alternating with the plurality of first electrodes in a planar view, and an opposing electrode opposing the plurality of first electrodes and the plurality of second electrodes, wherein the second electrode is insulated from the first electrode, and a width of the second electrode in the second direction intersecting the first direction is smaller than a width of the first electrode in the second direction.

A parallax barrier panel according to one embodiment of the present invention includes a first substrate, a second substrate opposing the first substrate, a liquid crystal layer between the first substrate and the second substrate, a plurality of first electrodes arranged between the first substrate and the liquid crystal layer, the plurality of first electrodes extending in a first direction, a plurality of second electrodes arranged between the plurality of first electrodes and the liquid crystal layer, the plurality of second electrodes extending in the first direction and arranged alternating with the plurality of first electrodes in a planar view, and an opposing electrode opposing the plurality of first electrodes and the plurality of second electrodes, wherein the second electrode is insulated from the first electrode, and is supplied with a smaller voltage than the first electrode.

A method of driving a parallax barrier panel according to one embodiment of the present invention wherein a long axis of a liquid crystal molecule included in the liquid crystal layer is arranged in a perpendicular direction to the first substrate when a driving voltage is applied, and a total of the number of adjacent first electrodes applied with the driving voltage among the plurality of first electrodes and adjacent second electrodes applied with the driving voltage among the plurality of second electrodes is an even number in the case of forming a parallax barrier.

### BRIEF DESCRIPTION OF DRAWINGS

FIG. 1 is a cross-sectional diagram showing a summary of a display device using a barrier panel related to one embodiment of the present invention;

FIG. 2 is a cross-sectional diagram showing a summary of a barrier panel related to one embodiment of the present invention;

FIG. 3 is a planar view diagram of a first electrode of a barrier panel related to one embodiment of the present invention;

FIG. 4 is a planar view diagram of a second electrode of a barrier panel related to one embodiment of the present invention;

FIG. 5 is a planar view diagram of showing a pixel layout in a semiconductor device using a barrier panel related to one embodiment of the present invention;

FIG. 6A is cross-sectional diagram showing an OFF state in an operation of a barrier panel related to one embodiment of the present invention;

FIG. 6B is cross-sectional diagram showing an ON state in an operation of a barrier panel related to one embodiment of the present invention;

FIG. 7A is a schematic diagram for explaining the principle of a 3D image display using a barrier panel related to one embodiment of the present invention;

FIG. 7B is a schematic diagram for explaining the principle of method for tracking the position of an eye of a user in a 3D image display using a barrier panel related to one embodiment of the present invention;

FIG. 8 is a cross-sectional diagram showing a positional relationship between a first electrode and a second electrode of a barrier panel related to one embodiment of the present invention;

FIG. 9 is a schematic diagram showing barrier characteristics with respect to driving a barrier panel related to one embodiment of the present invention;

FIG. 10 is a schematic diagram showing a track drive method of a barrier panel and barrier characteristics when a track drive method r is performed related to one embodiment of the present invention;

FIG. 11 shows the evaluation results a variation value in barrier width with respect to a different in a first electrode width and a second electrode width of a barrier panel related to one embodiment of the present invention;

FIG. 12 shows the evaluation results a variation value in barrier width with respect to a different in a first electrode width and a second electrode width of a barrier panel related to one embodiment of the present invention;

FIG. 13A is a cross-sectional diagram showing a driving method of a barrier panel and a positional relationship between a first electrode and a second electrode related to one embodiment of the present invention;

FIG. 13B is a cross-sectional diagram showing a track drive method of a barrier panel and a positional relationship between a first electrode and a second electrode related to one embodiment of the present invention;

FIG. 13C is a cross-sectional diagram showing a track drive method of a barrier panel and a positional relationship between a first electrode and a second electrode related to one embodiment of the present invention;

FIG. 14A is a cross-sectional diagram showing a driving method of a barrier panel and a positional relationship between a first electrode and a second electrode related to one embodiment of the present invention;

FIG. 14B is a cross-sectional diagram showing a track drive method of a barrier panel and a positional relationship between a first electrode and a second electrode related to one embodiment of the present invention;

FIG. 14C is a cross-sectional diagram showing a track drive method of a barrier panel and a positional relationship between a first electrode and a second electrode related to one embodiment of the present invention;

FIG. 15 is a cross-sectional diagram showing a positional relationship between a first electrode and a second electrode of a barrier panel related to one embodiment of the present invention;

FIG. 16 is a cross-sectional diagram showing a positional relationship between a first electrode, a second electrode and a third electrode of a barrier panel related to one embodiment of the present invention;

FIG. 17 is a cross-sectional diagram showing a positional relationship between a first electrode, a second electrode and a third electrode of a barrier panel related to one embodiment of the present invention;

FIG. 18 is a cross-sectional diagram showing a positional relationship between a first electrode and a second electrode of a barrier panel related to one embodiment of the present invention;

FIG. 19 is a cross-sectional diagram showing a positional relationship between a first electrode and a second electrode of a barrier panel related to one embodiment of the present invention;

FIG. 20A is a schematic diagram showing a driving method of a barrier panel and barrier characteristics when the barrier panel is driven related to one embodiment of the present invention;

FIG. 20B is a schematic diagram showing a driving method of a barrier panel and barrier characteristics when the barrier panel is driven related to a comparative example of the present invention; and

FIG. 21 is a schematic diagram showing a driving method of a barrier panel and barrier characteristics when the barrier panel is driven related to one embodiment of the present invention.

### DESCRIPTION OF EMBODIMENTS

The embodiments of the present invention are explained below while referring to the diagrams. Furthermore, the disclosure is merely an example and appropriate modifications that could be easily conceived while maintaining the concept of the present invention and included within the scope of the present invention. Although the width, thickness and shape of each component are shown schematically compared to their actual form in order to better clarify explanation, the drawings are merely an example and should not limit an interpretation of the present invention. In addition, in the specification and each drawing, the same reference symbols are attached to similar elements and elements that have been mentioned in previous drawings, and therefore a detailed explanation may be omitted where appropriate.

In addition, although an explanation is provided using the terms upwards and downwards, for convenience of explanation, for example the vertical relationship between a first component and a second component may be reversely arranged to the diagrams. In addition, in the explanation below, the expression a second component above a first component for example merely explains a vertical relationship between the first component and second component as described above, and other components may also be arranged between the first component and second component. In addition, even in the case where a second component is arranged below a first component in the diagrams, the case where a second component is formed above a first component in a manufacturing process may be expressed as the second component above the first component. The embodiments herein aim to provide a barrier panel with high controllability of a barrier region.

### First Embodiment

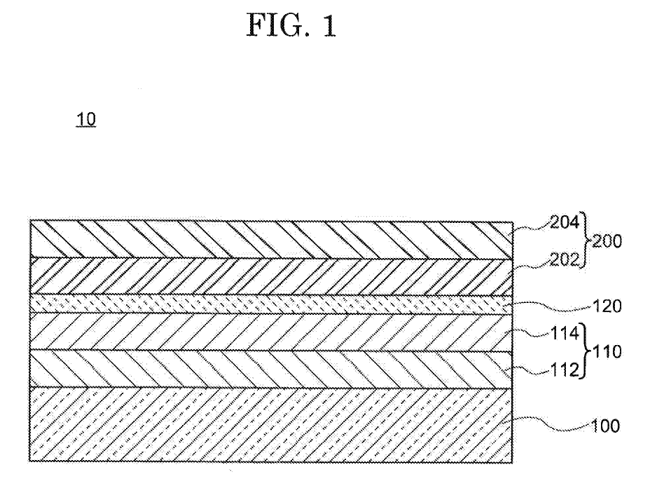

A summary of a display device using a barrier panel related to one embodiment of the present invention is explained using FIG. 1. In FIG. 1, an example using a liquid crystal display device is explained as a display panel.

### Structure of Display Device 10

FIG. 1 is a cross-sectional diagram showing a summary of a display device 10 using a barrier panel related to one embodiment of the present invention. As is shown in FIG. 1, the display device 10 includes a backlight 100, a LCD substrate 110, an adhesion layer 120 and a barrier panel 200. The LCD substrate 110 is arranged above the backlight 100. The LCD substrate 110 includes a transistor array substrate 112 and an opposing substrate 114. The barrier panel 200 includes a first substrate 202 and a second substrate 204. The adhesion layer 120 is arranged between the LCD substrate 110 and the barrier panel 200 and fixes them together.

A cold cathode fluorescent lamp, LED, laser or organic EL and the like are used as the light source of the backlight 100. In addition, the irradiation method of the backlight 100 may be an edge light method or a direct backlight method. Furthermore, in the case where an organic EL is used as the light source, the irradiation method of the backlight is a surface light emitting direct backlight method.

The LCD substrate 110 is a display substrate including liquid crystals (not shown in the diagram) between the transistor array substrate 112 and opposing substrate 114. The LCD substrate 110 may be a vertical alignment type or horizontal electric field driven type. A plurality of transistors is arranged in the transistor array substrate 112. Amorphous silicon, polysilicon, single crystal silicon, oxide semiconductor, compound semiconductor or organic semiconductor and the like are used as a channel of these transistors. Here, the backlight 100 and LCD substrate 110 may be collectively referred to as a display substrate.

Here, although a structure in which the backlight 100 and LCD substrate 110 are used in the display device 10 is exemplified in FIG. 1, the present invention is not limited to this structure. For example, an organic light emitting diode or reflective type display device such as electronic paper and the like may also be used instead of the backlight 100 and LCD substrate 110.

### Structure of a Barrier Panel 200

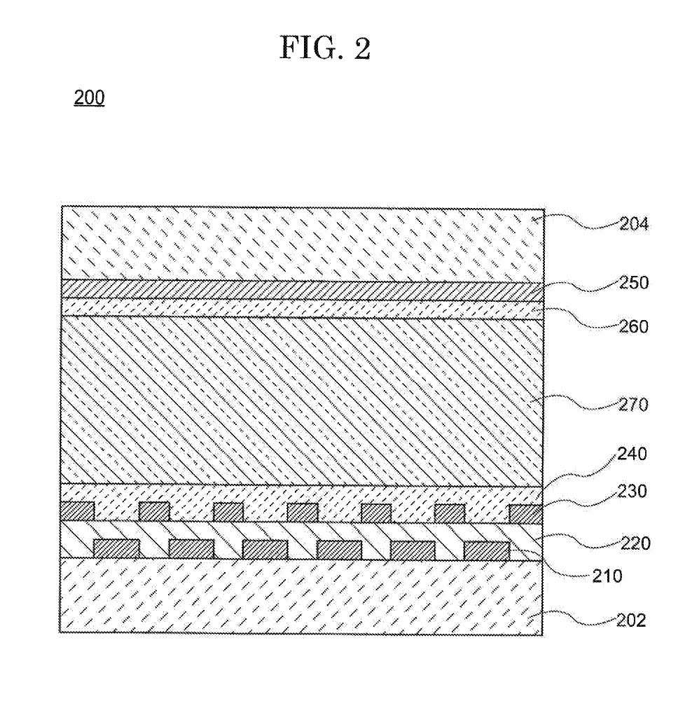

FIG. 2 is a cross-sectional diagram showing a summary of a barrier panel related to one embodiment of the present invention. As is shown in FIG. 2, the barrier panel 200 includes a first substrate 202, a second substrate 204, a first electrode 210, an insulation layer 220, a second electrode 230, a first alignment film 240, a common electrode 250, a second alignment film 260 and a liquid crystal layer 270. The first substrate 202 and second substrate 204 oppose each other. In FIG. 2, an insulation layer covering the second electrode 230 may be arranged between the second electrode 230 and first alignment film 240.

A plurality of the first electrodes 210 is arranged above the first substrate 202. The insulation layer 220 is arranged above the first electrode 210 and covers an upper surface and side surface of the first electrode 210. A plurality of the second electrodes 230 is arranged above the first insulation layer 220. The first alignment film 240 is arranged above the second electrode 230 and covers an upper surface and side surface of the second electrode 230. The common electrode 250 is arranged opposing the plurality of first electrodes 210 and plurality of second electrodes 230 above the second substrate 204.

The second alignment film 260 is arranged above the common electrode 250. The liquid crystal layer 270 is arranged between the first alignment film 240 and second alignment film 260. Although described in detail herein, the width of the second electrode 230 is smaller than the width of the first electrode 210.

In other words, the liquid crystal layer 270 is arranged between the first substrate 202 and second substrate 204. The plurality of first electrodes 210 is arranged between the first substrate 202 and the liquid crystal layer 270. The plurality of second electrodes 230 is arranged between the plurality of first electrodes 210 and the liquid crystal layer 270. The first electrode 210 and second electrode 230 are insulated by the first insulation layer 220.

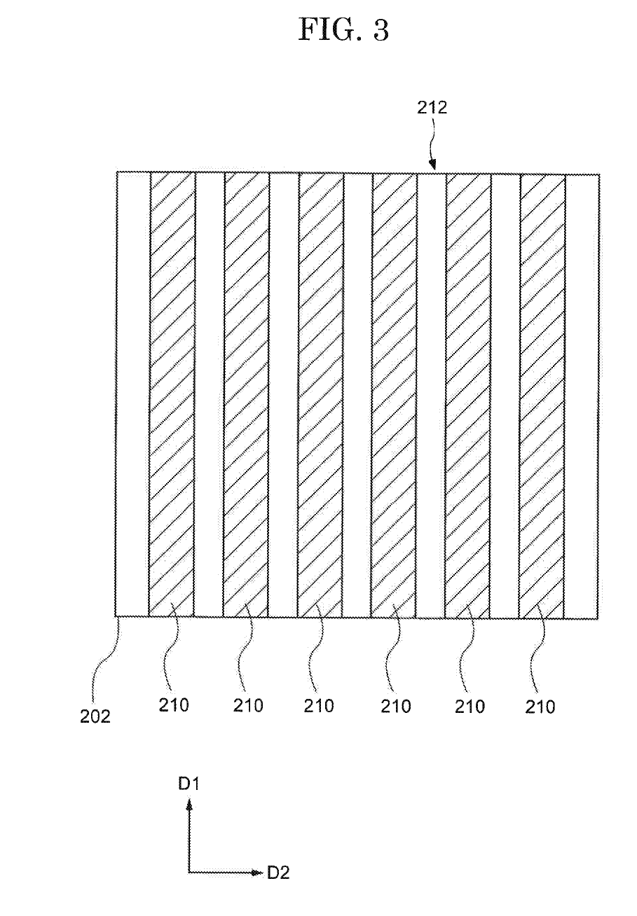

FIG. 3 is a planar diagram of a first electrode in a barrier panel related to one embodiment of the present invention. As is shown in FIG. 3, the first electrode 210 extends in a first direction D1. That is, the first electrode 210 is arranged in a pattern which extends in the direction D1. In other words, the pattern of the first electrode 210 has longitudinal in the direction D1. A first space 212 is arranged between adjacent first electrodes 210.

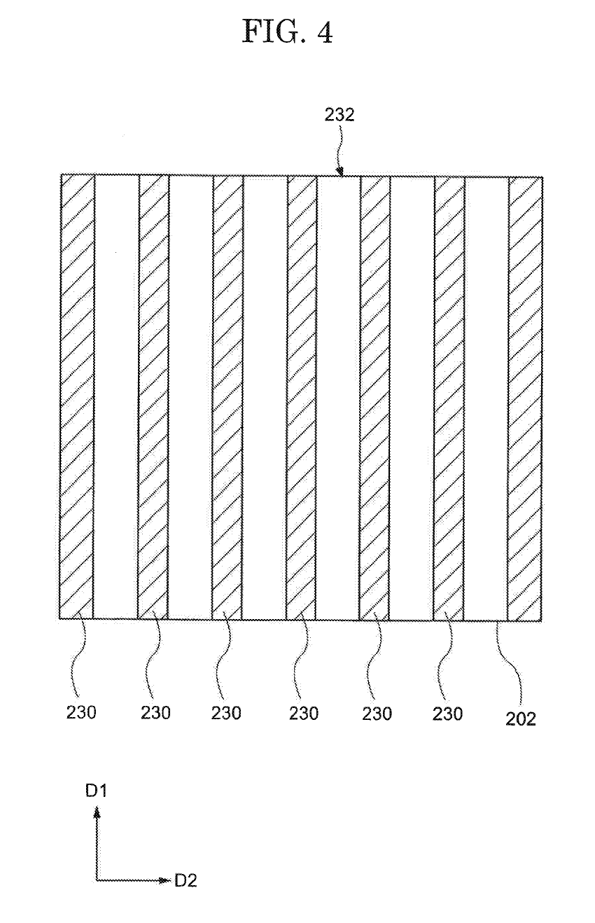

FIG. 4 is a planar diagram of a second electrode in a barrier panel related to one embodiment of the present invention. As is shown in FIG. 4, the second electrode 230 extends in the direction D1 the same as the first electrode 210. A second space 232 is arranged between adjacent second electrodes 230.

Referring to FIG. 3 and FIG. 4, in a planar view the second electrode 230 is arranged at a position corresponding to the first space 212 and the first electrode 210 is arranged at a position corresponding to the second space 232. That is, the first electrode 210 and the second electrode 230 are alternately arranged in a planar view. The width of the second electrode 230 in a second direction D2 is smaller than the width of the first electrode 210 in the second direction D2. The second direction D2 intersects the first direction D1. Herein, the width of the first electrode 210 in the second direction D2 is simply referred to as the width of the first electrode 210, and the width of the second electrode 230 in the second direction D2 is simply referred to as the width of the second electrode 230.

The difference between the width of the first electrode 210 and the width of the second electrode 230 is 1.0 μm or more and 6.0 μm or less. Preferably the difference between the width of the first electrode 210 and the width of the second electrode 230 is 1.0 μm or more and 5.0 μm or less. More preferably, the difference between the width of the first electrode 210 and the width of the second electrode 230 is 2.0 μm or more and 4.0 μm or less.

Here, although a planar layout is exemplified in FIG. 3 and FIG. 4 in which an end part of a pattern of the first electrode 210 and an end part of a pattern of the second electrode 230 match in a planar view, the present invention is not limited to this structure. For example, the first electrode 210 may partially overlap with the second electrode 230 in a planar view. Alternatively, in a planar view, an end part of a pattern of the first electrode 210 does not overlap with an end part of a pattern of the second electrode 230 and an offset may be arranged therebetween. In other words, the first space 211 may partially overlap with the second space 232 in a planar view.

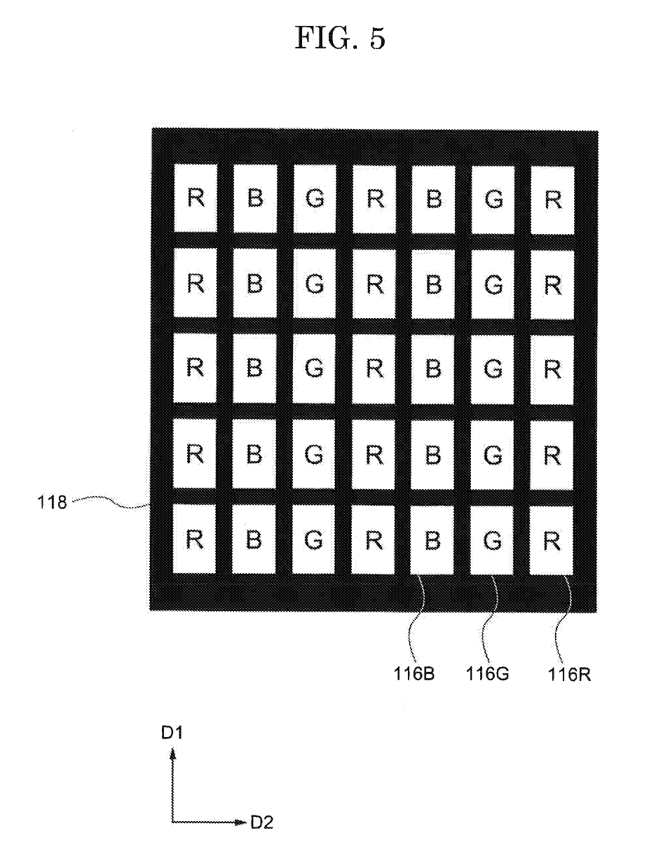

FIG. 5 is a planar view diagram showing a pixel layout of a display substrate using the barrier panel related to one embodiment of the present invention. The layout shown in FIG. 5 illustrates a layout including a red color filter 116R (sub-pixel R), a green color filter 116G (sub-pixel G), a blue color filter 116B (sub-pixel B), and a light blocking member 118 (black matrix for example). As is shown in FIG. 5, the sub-pixel R, sub-pixel G and sub-pixel B are arranged in the first direction D1. One pixel is formed by the sub-pixel R, sub-pixel G and sub-pixel B. As described above, the direction in which the first electrode 210 and second electrode 230 extend matches the arrangement direction of a plurality of sub-pixels which form one pixel. By adopting such a layout, it is possible to suppress the occurrence of unevenness in a light blocking area of three colors RGB in one pixel when a track drive method of a barrier is performed.

Although a pixel layout is exemplified in FIG. 5 in which pixels adjacent in the direction D2 are pixels of the same color, the present invention is not limited to this pixel layout. For example, a pixel layout is possible in which pixels adjacent in the direction D2 are pixels of different colors. Specifically, a layout is possible in which pixels adjacent in the direction D2 with respect to a sub-pixel R serve as a sub-pixel G or a sub-pixel B.

### Material of Each Component in a Barrier Panel 200

The material of each component (each layer) included in the barrier panel 200 shown in FIG. 1 is explained in detail.

It is possible to use a transparent conductive layer as the first electrode 210, second electrode 230 and common electrode 250. It is possible to use a conductive oxide such as ITO (Indium Tin Oxide), IZO (Indium Zinc Oxide), or GZO (Zinc Oxide added with Gallium as a dopant) as the transparent conductive layer. In addition, a structure in which these films are stacked may also be used.

It is possible to use an inorganic insulation material or an organic insulation material as the insulation layer 220. It is possible to use a layer of silicon nitride (SiNₓ), silicon nitride oxide (SiNₓO_{y}), silicon oxide (SiOₓ), silicon oxynitride (SiOₓN_{y}), aluminum nitride (AlNₓ), aluminum nitride oxide (AlNₓO_{y}), aluminum oxide (AlOₓ), aluminum oxynitride (AlOₓN_{y}) or TEOS (Tetra Ethyl Ortho Silicate) as the inorganic insulation material (x and y are integers). In addition, a structure is also possible in which these films are stacked.

It is possible to use a polyimide resin, acrylic resin, epoxy resin, silicon resin, a fluororesin or siloxane resin and the like as the organic insulation material. The insulation layer 220 may be a single layer of the materials described above or a stacked layer. For example, an inorganic insulation material and an organic insulation material may be stacked.

It is possible to use an organic insulation material which has undergone a photo alignment process or rubbing process as the first alignment film 240 and second alignment film 260. It is possible to use polyimide as the first alignment film 240 and second alignment film 260. However, it is also possible to use the organic insulation materials descried above other than polyimide. It is possible to use a TN (Twisted Nematic) method, VA (Vertical Alignment) method or IPS (In-Plane-Switching) method as the driving method of the liquid crystal layer 270. It is preferred to use a TN method as the driving method of the liquid crystal layer 270. In the embodiments below, an explanation is provided in which a rubbing process is used as the alignment process and a TN method is used as the driving method of liquid crystals.

### Operation of Barrier Panel 200

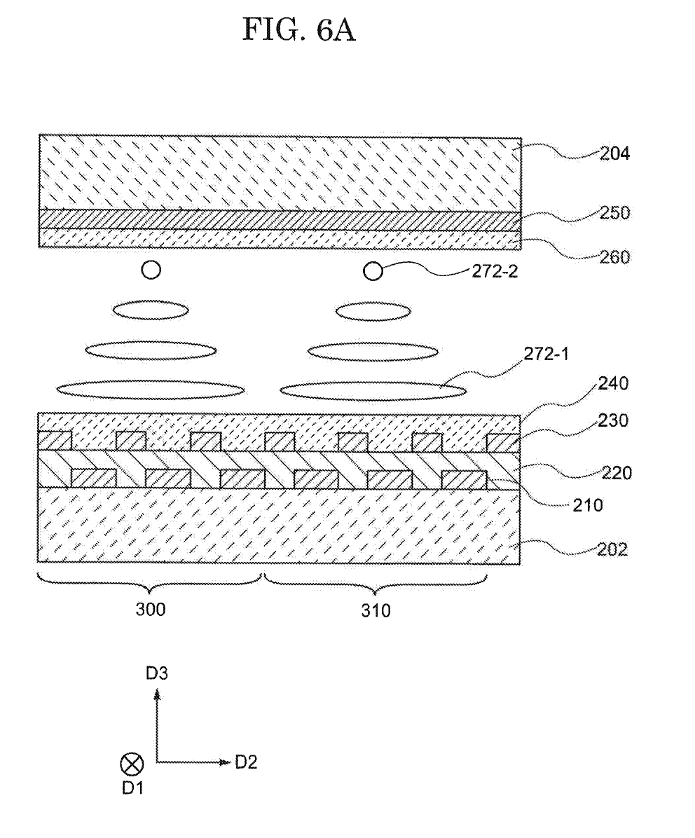

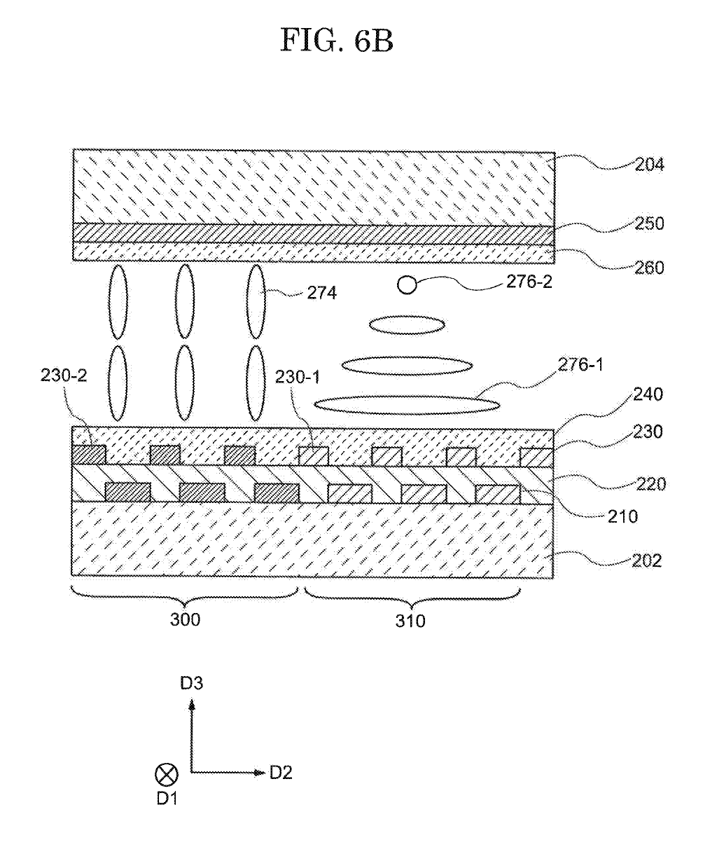

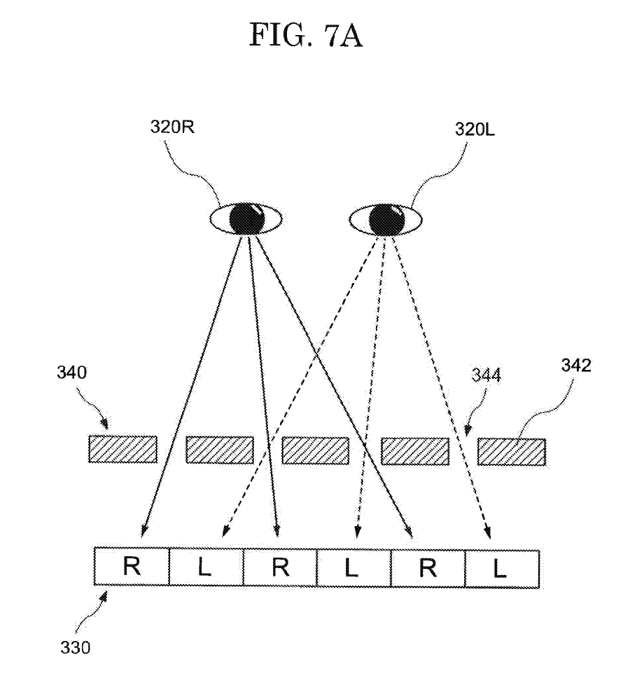

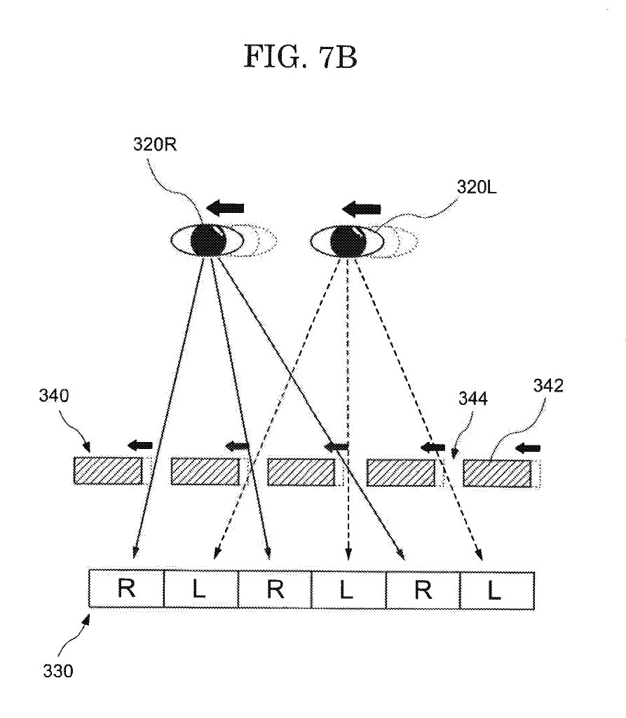

The operation of the barrier panel 200 is explained using FIG. 6A to FIG. 7B. FIG. 6A and FIG. 6B are cross-sectional diagrams showing an OFF state and an ON state in an operation of the barrier panel related to one embodiment of the present invention. The driving method of the liquid crystal layer 270 explained herein is a twist alignment TN method. That is, the alignment direction of the first alignment film 240 and second alignment film 260 is different by about 90°.

In the first region 300 and second region 310 in FIG. 6A, there is not potential difference between the first electrode 210, second electrode 230 and common electrode 250. Therefore, liquid crystal molecules 272 are aligned along a rubbing direction of each of the first alignment film 240 and second alignment film 260. As is shown in FIG. 6A, liquid crystal molecules 272-1 are aligned in the direction D2 in the vicinity of the first alignment film 240, and liquid crystal molecules 272-2 are aligned in the direction D1 in the vicinity of the second alignment film 260. Here, the direction D1 is the same direction as the direction D1 shown in FIG. 3 for example. In this way, a barrier is not formed in the first region 300 and second region 310, and all the pixels displayed by the LCD substrate 110 are visible to a user.

In FIG. 6B, a drive voltage is supplied to the first electrode 210 and second electrode 230 in the first region 300, and a potential difference is generated between the first electrode 210 and common electrode 250, and between the second electrode 230 and common electrode 250. The liquid crystal molecules 274 in the first region 300 are aligned according to an electric field produced by this potential difference. In FIG. 6B, the liquid crystal molecules 274 in the first region 300 are aligned in a third direction D3. Here, the third direction D3 is orthogonal to the first direction D1 and second direction D2. For example, the direction D3 corresponds to a plate/thickness direction of the first substrate 202. That is, the length axis of the liquid crystal molecules 274 in the first region 300 is aligned in a direction perpendicular to the first substrate 202 and second substrate 204 by supply of a drive voltage. On the other hand, since there is no potential difference between the first electrode 210 and common electrode 250, and between the second electrode and common electrode 250 in the second region 310, the liquid crystal molecules 276 are aligned along a rubbing direction of each of the first alignment film 240 and second alignment film 260. Therefore, as is shown in FIG. 6B, liquid crystal molecules 276-1 are aligned in the direction D2 in the vicinity of the first alignment film 240, and liquid crystal molecules 276-2 align in the direction D1 in the vicinity of the second alignment film 260. As described above, since a barrier is formed in the first region 300, among the pixels displayed on the LCD substrate 110, only a pixel in a region corresponding to the second region 310 is visible to a user.

FIG. 7A is a schematic diagram for explaining the principle of a 3D image display using the barrier panel related to one embodiment of the present invention. As is shown in FIG. 7A, a barrier panel 340 is arranged between the right eye 320R of a user and a display substrate 330, and between the left eye 320L of a user and a display substrate 330. An image for the right eye [R] and an image for the left eye [L] are alternately displayed in the display substrate 330. A light blocking region 342 and translucent region 344 are arranged in the barrier panel 340. By controlling the position of the light blocking region 342 and translucent region 344, only the image [R] is visible to the right eye 320R, and only the image [L] is visible to the left eye 320L.

FIG. 7B is a schematic diagram for explaining the principle of a method for tracking the position of a user's eye in a 3D image display using the barrier panel related to one embodiment of the present invention. As is shown in FIG. 7B, when a user moves (when the right eye 320R and left eye 320L move), the light blocking region 342 and translucent region 344 of the barrier panel 340 move based on a detection of the user's eyes. In this way, by controlling the position of the light blocking region 342 and translucent region 344, only the image [R] is visible to the right eye 320R and only the image [L] is visible to the left eye 320L even after the position of the user has moved.

The positional control of the light blocking region 342 and translucent region 344 described above is realized by control of the first electrode 210 and second electrode 230 shown in FIG. 6A and FIG. 6B. When explained in detail using FIG. 6B, in order to move the first region 300 which serves as a light blocking region, in a planar view, a drive voltage is supplied to the second electrode 230-1 adjacent to the farthest right first electrode 210 in the first region 300 (farthest left second electrode 230 in the second region 310), and supply of a drive voltage to the farthest left second electrode 230-2 in the first region 300 is stopped. In this way, a barrier moves in a right direction by the width amount of the second electrode 230.

Here, it is possible to use a method for analyzing an image taken by a camera arranged in a display device as a method for detecting the position of a user's eyes. In this method, user facial recognition is performed based on an image taken by a camera and position data of a user's eyes is acquired.

### Controllability Evaluation of Barrier Panel 200

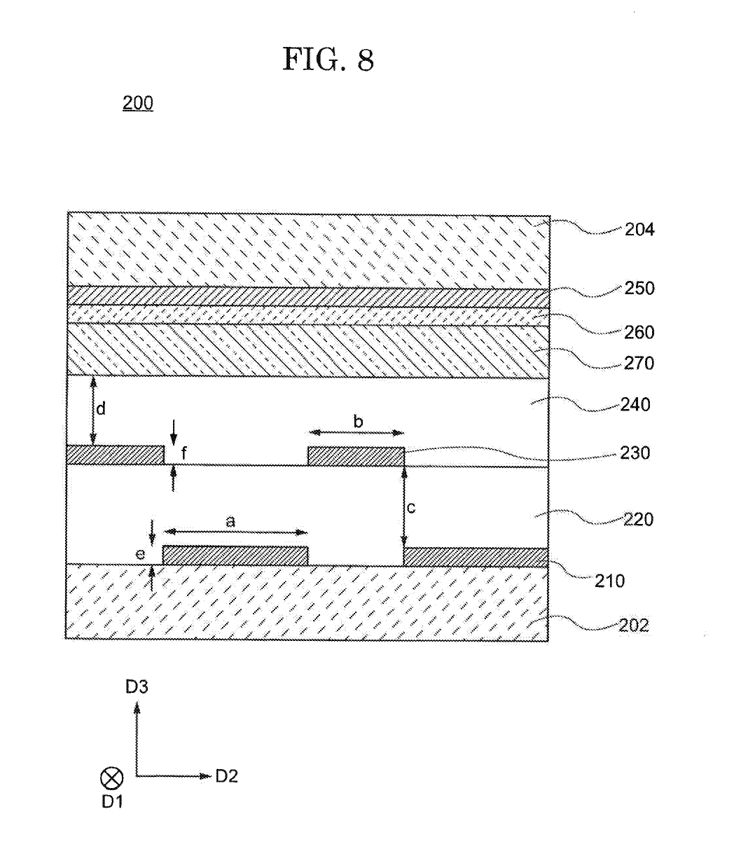

FIG. 8 is a cross-sectional diagram showing a positional relationship between a first electrode and second electrode in an evaluation of the barrier panel related to one embodiment of the present invention. In FIG. 8, the first electrode 210, the insulation layer 220, second electrode 230 and first alignment film 240 are displayed expanded in a thickness direction and the liquid crystal layer 270 is displayed reduced in a thickness direction.

[a]˜[f] shown in FIG. 8 are each as follows.

[a]: width of first electrode 210

[b]: width of second electrode 230

[c]: film thickness of insulation layer 220

[d]: distance from second electrode 230 to liquid crystal layer 270

[e]: film thickness of first electrode 210

[f]: film thickness of second electrode 230

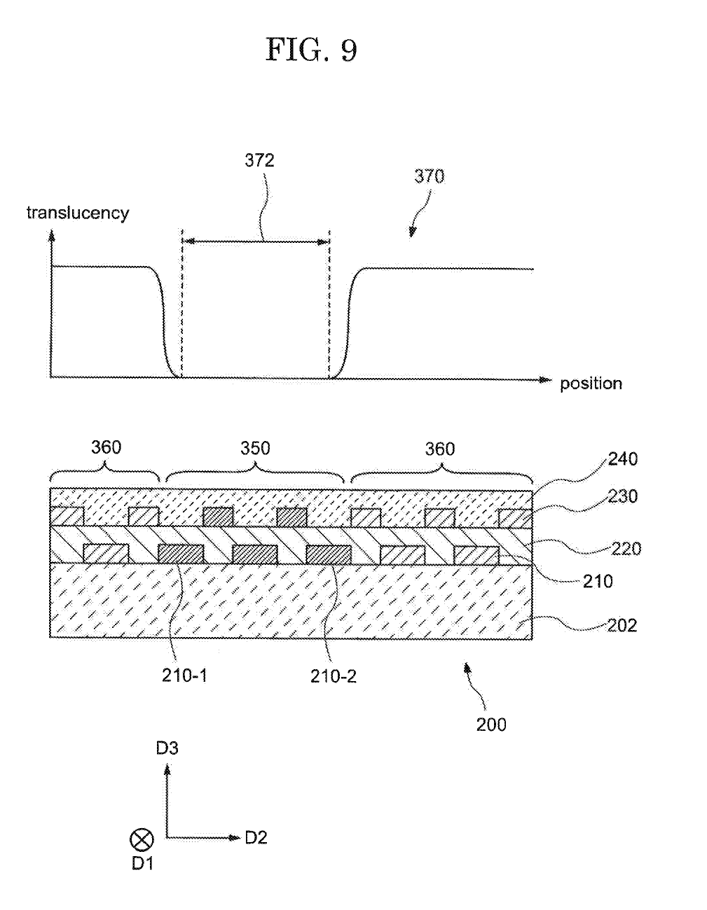

FIG. 9 is a schematic diagram showing barrier characteristics with respect to driving of the barrier panel related to one embodiment of the present invention. In FIG. 9, for the convenience of explanation, in the barrier panel 200, only the first substrate 202, the first electrode 210, insulation layer 220, second electrode 230 and first alignment film 240 are shown. As is shown in FIG. 9, a light blocking region is formed in the first region 350 by supplying a drive voltage to the first electrode 210 and second electrode 230 in the first region 350. A translucent region is formed in the second region 360 since a drive voltage is not supplied to the first electrode 210 and second electrode 230 in the second region 360. A spectrum 370 expresses the relationship a position in the second direction D2 of the first substrate 202 and translucency with respect to visible light of the barrier panel 200 in the state described above. The spectrum 370 is called barrier characteristics.

As is shown in the spectrum 370, translucency of a region corresponding to a position of the first region 350 which is a light blocking region is low. In the embodiments herein, a light blocking region is defined that the translucency of the light blocking region (barrier region 372) is 0.5% or less of the translucency of the maximum value of the spectrum 370. In other words, in the case where the translucency of the spectrum 370 (at a certain wavelength) is 5% or less compared to a maximum value of the spectrum 370 (at all wavelengths), it is defined that the light at that wavelength is blocked.

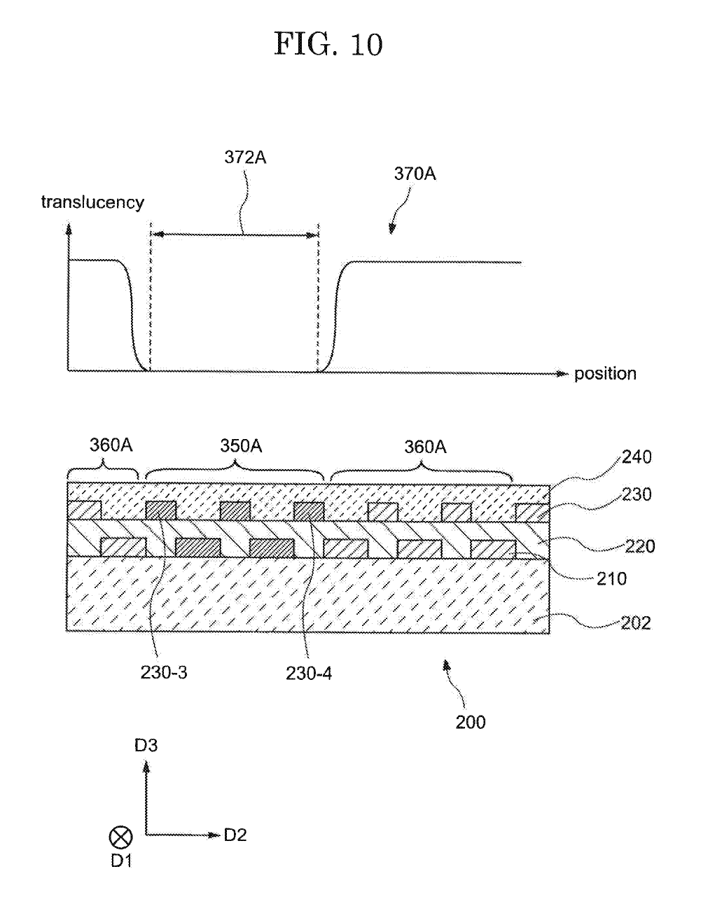

FIG. 10 is a schematic diagram showing a track drive method of a barrier panel and barrier characteristics at the time of performing a track drive method related to one embodiment of the present invention. FIG. 10 shows a state in which a barrier position is moved in a reverse direction (left direction) to the second direction D2 in FIG. 9. In FIG. 10, a left end of a first region 350A moves in a left direction by the width amount of the second electrode 230, and a right end of the first region 350A moves in a left direction by the width amount of the first electrode 210 with respect to FIG. 9. The barrier region 372A moves in a left direction together with the movement in a left direction of the first region 350A described above.

The position of both ends part of the barrier region 372 in FIG. 9 is determined by an electric field generated by the first electrodes 210-1, 210-2 corresponding to both ends of the first region 350. On the other hand, the position of both ends part of the barrier region 372A in FIG. 10 is determined by an electric field generated by the second electrodes 230-3, 230-4 arranged at both ends of the first region 350A. Here, when FIG. 9 and FIG. 10 are compared, the distance between the first electrode 210 and common electrode 250 is large compared to the distance between the second electrode 230 and common electrode 250. As a result, the positional relationship between an end part of the first electrode 210 and an end part of the barrier region 372 is different to the positional relationship between an end part of the second electrode 230 and an end part of the barrier region 372.

As a result of the above, as is shown in FIG. 9, an end part of the barrier region 372 is positioned further to the interior of the first region 350 than a pattern end of the first electrodes 210-1, 210-2 arranged at an end part of the first region 350. On the other hand, as is shown in FIG. 10, an end part of the barrier region 372A is almost the same as a pattern end of the second electrodes 230-3, 230-4 arranged at an end part of the first region 350A. That is, when the barrier region 372 is moved from the state in FIG. 9 to the state shown in FIG. 10, the width of the barrier region 372 changes in the second direction D2. The amount of this change is defined as a variation value in barrier width.

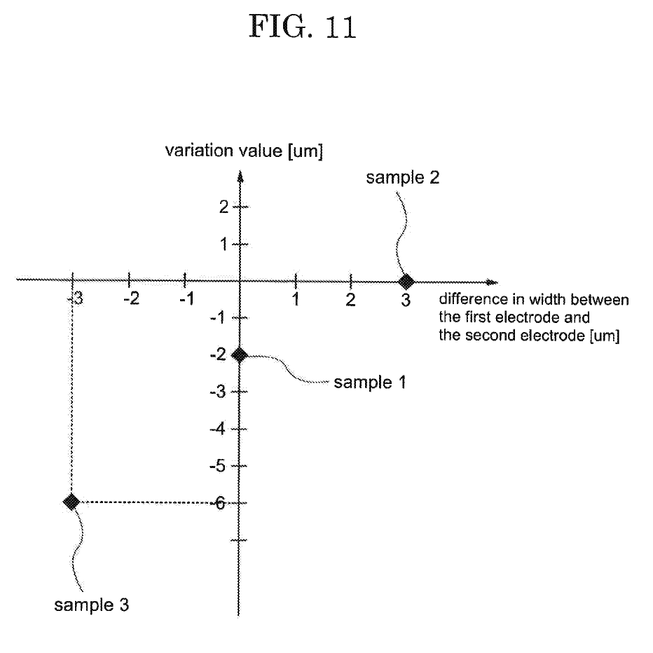

FIG. 11 shows the evaluation results of a variation value in barrier width with respect to a difference in a first electrode width and second electrode width in the barrier panel related to one embodiment of the present invention. The horizontal axis of the graph shown in FIG. 11 is a value obtained by subtracting the width of the second electrode 230 from the width of the first electrode 210 (described as difference in width between the first electrode and the second electrode in FIG. 11). In other words, the horizontal axis of the graph shown in FIG. 11 can be expressed by [a-b] using the parameters in FIG. 8. The vertical axis of the graph shown in FIG. 11 is a variation value of barrier width defined as described above. The evaluation results shown in FIG. 11 are the result of evaluating a variation value of barrier width with respect to a sample. The sample includes the parameters a˜f shown in FIG. 8 which indicate the values shown in table 1. As is shown in table 1, in a sample used in the evaluation in FIG. 11, a rubbing direction is 45° (or 135°) with respect to a side of the first substrate 202 and second substrate 204.

TABLE 1

| | Sample 1 | Sample 2 | Sample 3 |
|---|---|---|---|
| a | 6.5 μm | 8.0 μm | 5.0 μm |
| b | 6.5 μm | 5.0 μm | 8.0 μm |
| c | 200 μm | 200 μm | 200 μm |
| d | 4.0 μm | 4.0 μm | 4.0 μm |
| e | 77 nm | 77 nm | 77 nm |
| f | 77 nm | 77 nm | 77 nm |
| Rubbing | 45° | 45° | 45° |
| direction | | | |

As is shown in FIG. 11, in the case of sample 1 in which the width [a] of the first electrode 210 is the same as the width [b] of the second electrode 230, the variation value of a barrier width is −2 μm. However, in the case of sample 2 in which the difference between the first electrode and the second electrode ([a]-[b]) is 3.0 μm, the variation value of a barrier width is zero. On the other hand, in the case of sample 3 in which the difference between the first electrode and the second electrode ([a]-[b]) is −3.0 μm, the variation value of a barrier width is −6 μm. That is, when the width of the second electrode 230 is smaller than the width of the first electrode 210, it is possible to reduce the variation value of a barrier width. In particular, in the results in FIG. 11, by setting the difference between the first electrode and the second electrode to 3.0 μm, it is possible to bring a variation value of a barrier width close to zero.

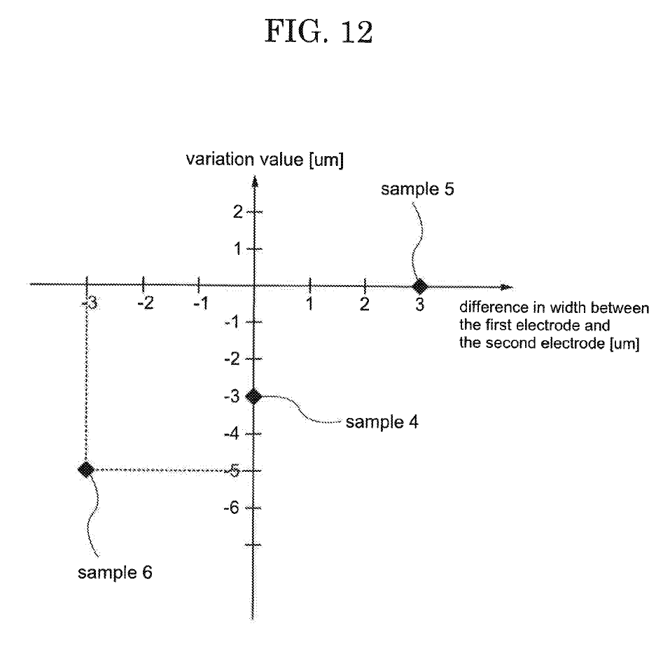

FIG. 12 shows the evaluation results of a variation value in barrier width with respect to a difference in a first electrode width and second electrode width in the barrier panel related to one embodiment of the present invention. The horizontal axis and vertical axis of the graph shown in FIG. 12 are the same as the horizontal axis and vertical axis of the graph shown in FIG. 11. The evaluation results shown in FIG. 12 are the result of evaluating a variation value of barrier width with respect to a sample. The sample includes the parameters a˜f shown in FIG. 8 which indicate the values shown in table 2. As is shown in table 2, in a sample used in the evaluation in FIG. 12, a rubbing direction is 0° (or 90°) with respect to a side of the first substrate 202 and second substrate 204.

TABLE 2

| | Sample 4 | Sample 5 | Sample 6 |
|---|---|---|---|
| a | 6.5 μm | 8.0 μm | 5.0 μm |
| b | 6.5 μm | 5.0 μm | 8.0 μm |
| c | 200 μm | 200 μm | 200 μm |
| d | 4.0 μm | 4.0 μm | 4.0 μm |
| e | 77 nm | 77 nm | 77 nm |
| f | 77 nm | 77 nm | 77 nm |
| Rubbing | 0° | 0° | 0° |
| direction | | | |

As is shown in FIG. 12, in the case of sample 4 in which the width [a] of the first electrode 210 and the width [b] of the second electrode 230 are the same, the variation value of a barrier width is −3 μm.

However, in the case of sample 5 in which the difference between the first electrode and the second electrode ([a]-[b]) is 3.0 μm, the variation value of a barrier width is zero. On the other hand, in the case of sample 3 in which the difference between the first electrode and the second electrode ([a]-[b]) is −3.0 μm, the variation value of a barrier width is −5 μm. That is, by designing the width of the second electrode 230 to a value smaller than the first electrode 210, it is possible to reduce the variation value of a barrier width. In particular, in the results in FIG. 1, by setting the difference between the first electrode and the second electrode to 3.0 μm, it is possible to bring a variation value of a barrier width close to zero.

The evaluation results when a barrier variation value becomes zero and the difference between the first electrode and the second electrode is 3.0 μm are shown in FIG. 11 and FIG. 12. However, the results described above do not limit the conditions for obtaining the effects of the present invention. In order to obtain the effects of the present invention, it is sufficient that at least the width of the second electrode 230 be made smaller than the width of the first electrode 210. The difference between the width of the first electrode 210 and the width of the second electrode 230 may be 1.0 μm or more and 6.0 μm or less. Preferably, he above described difference is 1.0 μm or more and 5.0 μm or less and more preferably 2.0 μm or more and 4.0 μm or less.

As described above, according to the barrier panel related to the first embodiment, by setting the width of the second electrode 230 to a smaller value than the width of the first electrode 210, it is possible to suppress a variation value in a barrier width when the barrier moves. That is, it is possible to provide a barrier panel with high barrier region controllability. By setting a difference between the width of the first electrode 210 and the width of the second electrode 230 to 1.5 μm or more and 5.0 μm or less, it is possible to further suppress a variation value in a barrier width.

### Second Embodiment

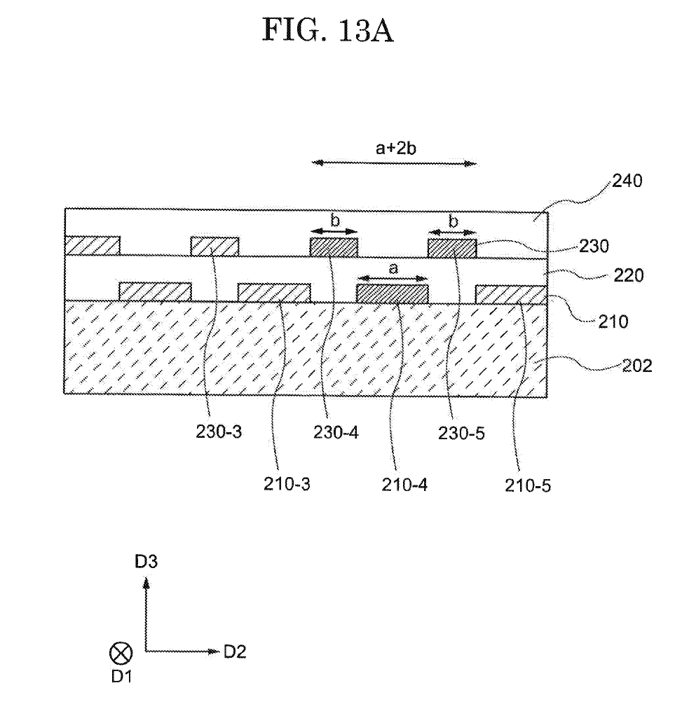

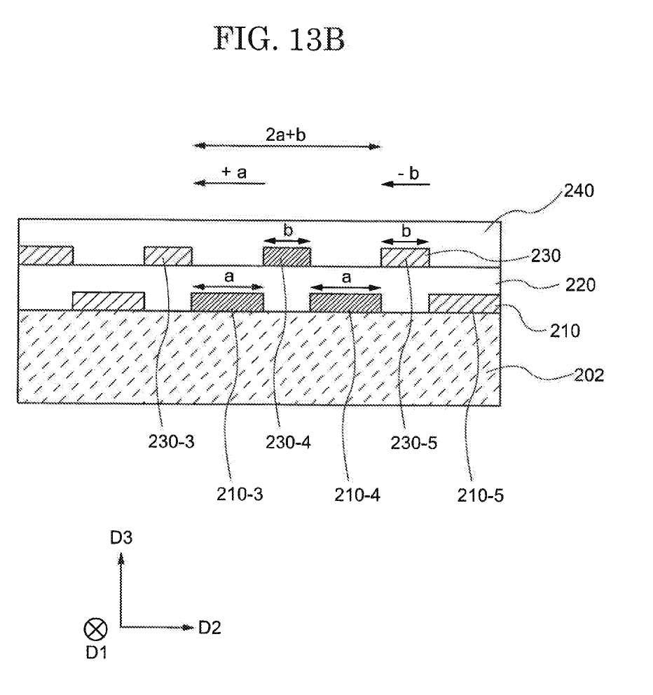

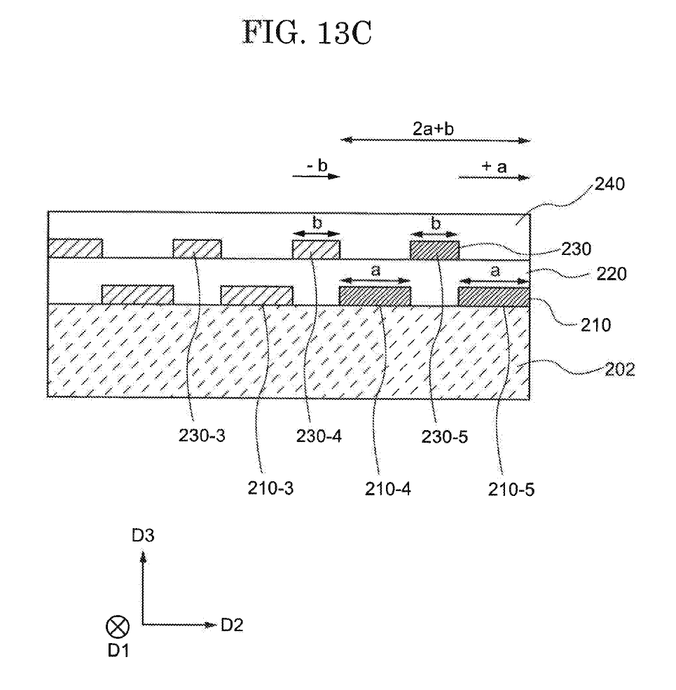

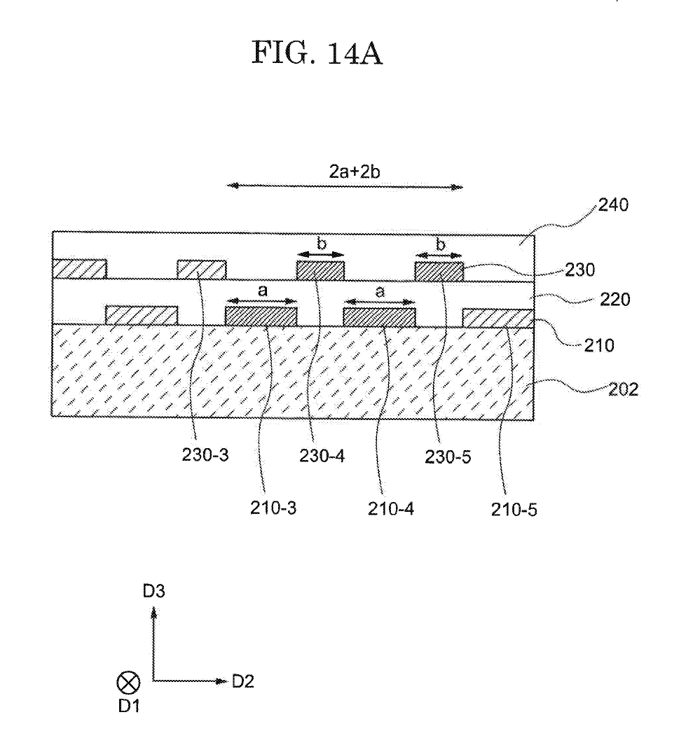

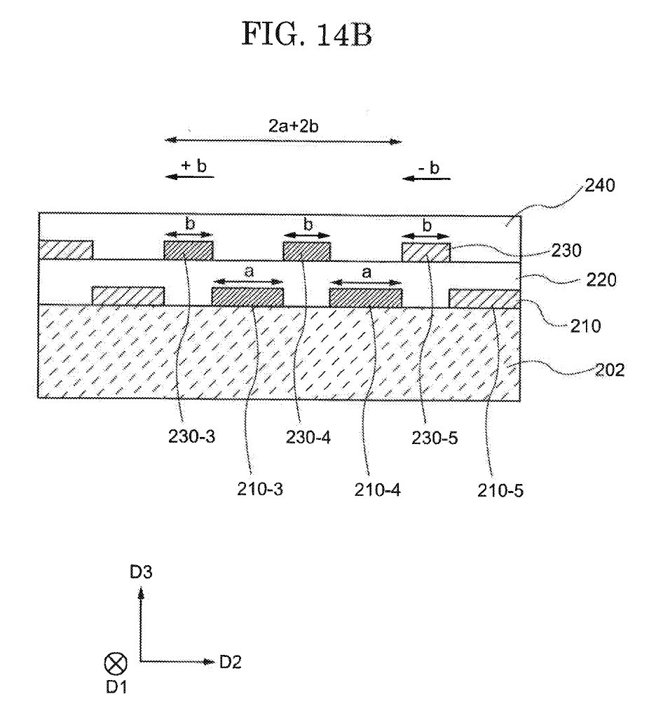

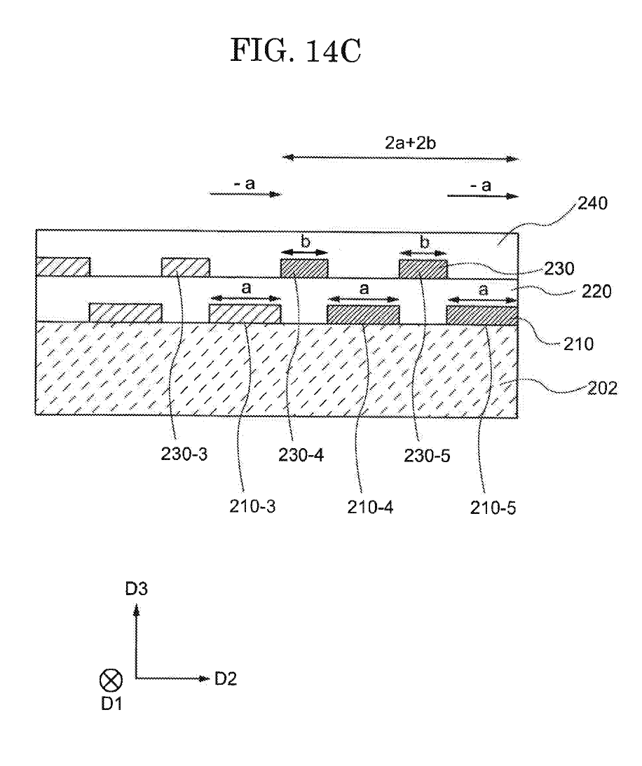

A driving method of a barrier panel related to one embodiment of the present invention is explained using FIG. 13A to FIG. 14C. The case where the sum of first electrodes 210 and second electrodes 230 driven in order to form a barrier is an odd number is shown in FIG. 13A to FIG. 13C. The case where the sum of first electrodes 210 and second electrodes 230 driven in order to form a barrier is an even number is shown in FIG. 14A to FIG. 14C.

FIG. 13A is a cross-sectional diagram showing a method of driving a barrier panel and a positional relationship between a first electrode and a second electrode related to one embodiment of the present invention. In FIG. 13A, by supplying a drive voltage to the first electrode 210-4 and second electrode 230-4, 230-5, a barrier corresponding to an electrode with a width of [a+2b] is formed. Here, the width of the first electrode 210 is set as [a] and the width of the second electrode 230 is set as [b] the same as the definition in FIG. 8.

FIG. 13B and FIG. 13C are cross-sectional diagrams showing a track drive method of a barrier panel and a positional relationship between a first electrode and a second electrode related to one embodiment of the present invention. FIG. 13B shows a state of a barrier being moved in a left direction from the state shown in FIG. 13A. The barrier moves by newly supplying a drive voltage to the first electrode 210-3, and stopping the supply of a drive voltage supplied to the second electrode 230-5. That is, the barrier widens corresponding to the width [a] of the first electrode 210-3 in a left direction, and becomes narrower corresponding to the width [b] of the second electrode 230-5 in a left direction, thereby the barrier moves from FIG. 13A and FIG. 13B. Due to this movement, an electrode width which forms a barrier changes from [a+2b] to [2a+b].

In addition, FIG. 13C shows a state of a barrier being moved in a right direction from the state shown in FIG. 13A. The barrier moves by newly supplying a drive voltage to the first electrode 210-5, and stopping the supply of a drive voltage supplied to the second electrode 230-4.

That is, the barrier widens corresponding to the width [a] of the first electrode 210-5 in a right direction, and becomes narrower corresponding to the width [b] of the second electrode 230-4 in a right direction, thereby the barrier moves from FIG. 13A to FIG. 13C. Due to this movement, an electrode width which forms a barrier changes from [a +2b] to [2a+b].

By making the sum of first electrodes 210 and second electrodes 230 which are driven in order to form a barrier an odd number as is shown in FIG. 13A to FIG. 13C, it is possible to make the amount of movement when a barrier is moved to the left and the amount of movement when a barrier is moved to the right from a certain reference state (for example, the state shown in FIG. 13A) the same.

FIG. 14A is a cross-sectional diagram showing a method of driving a barrier panel and a positional relationship between a first electrode and a second electrode related to one embodiment of the present invention. In FIG. 14A, by supplying a drive voltage to the first electrodes 210-3, 210-4 and second electrodes 230-4, 230-5, a barrier with a width of [2a+2b] is formed. That is, in FIG. 14A, the sum of the number of first electrodes 210 supplied with a drive voltage among the plurality of first voltages 210 and the number of second electrodes 230 supplied with a drive voltage among the plurality of second voltages 230 is an even number. Here, the width of the first electrode 210 is set as [a] and the width of the second electrode 230 is set as [b] the same as the definition in FIG. 8.

FIG. 14B and FIG. 14C are cross-sectional diagrams showing a track drive method of a barrier panel and a positional relationship between a first electrode and a second electrode related to one embodiment of the present invention. FIG. 14B shows a state of a barrier being moved in a left direction from the state shown in FIG. 14A. The barrier moves by newly supplying a drive voltage to the second electrode 230-3, and stopping the supply of a drive voltage supplied to the second electrode 230-5. That is, the barrier widens corresponding to the width [b] of the second electrode 230-3 in a left direction, and becomes narrower corresponding to the width [b] of the second electrode 230-5 in a left direction, thereby the barrier moves from FIG. 14A and FIG. 14B. The width of a barrier is maintained at [2a+2b] before and after this movement.

In addition, FIG. 14C shows a state of a barrier being moved in a right direction from the state shown in FIG. 14A. The barrier moves by newly supplying a drive voltage to the first electrode 210-5, and stopping the supply of a drive voltage supplied to the first electrode 210-3. That is, the barrier widens corresponding to the width [a] of the first electrode 210-5 in a right direction, and becomes narrower corresponding to the width [a] of the first electrode 210-3, thereby the barrier moves from FIG. 14A to FIG. 14C. The width of a barrier is maintained at [2a+2b] before and after this movement.

As shown in FIG. 14A to FIG. 14C, by setting the sum of the first electrodes 210 and the second electrodes 230 which are driven in order to form a barrier to an even number, it is possible to suppress a change in barrier width that accompanies movement of the barrier. Although an example in which the sum of the first electrodes 210 and the second electrodes 230 supplied with a drive voltage is four is shown in FIG. 14A to FIG. 14C, the present invention is not limited to this number and an even number larger than four is possible.

As described above, according to the barrier panel related to the second embodiment, it is possible to suppress a movement amount or change in barrier width that accompanies movement of a barrier by controlling the number of the sum of the first electrodes 210 and the second electrodes 230 supplied with a drive voltage.

### Third Embodiment

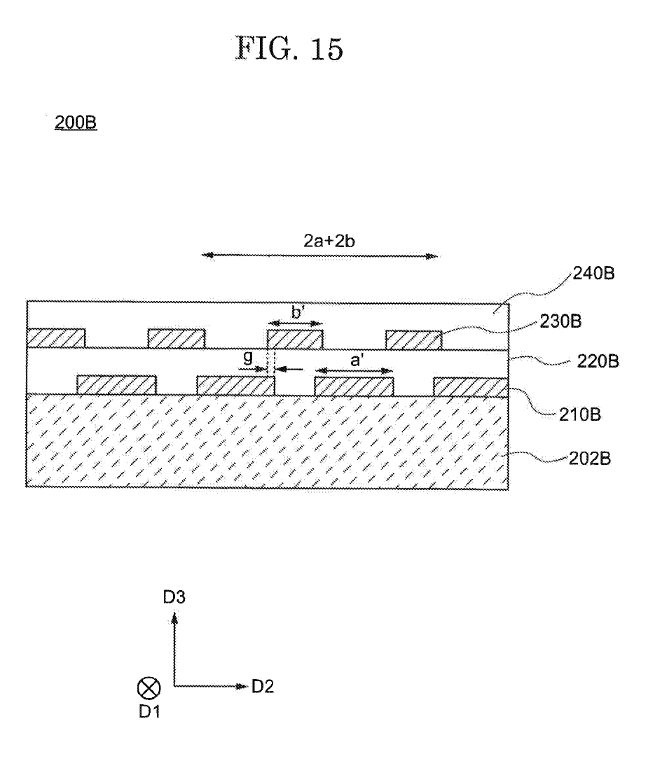

A structure of a barrier panel 200 B related to a third embodiment of the present invention is explained using FIG. 15. FIG. 15 is a cross-sectional diagram showing a positional relationship between a first electrode and a second electrode of a barrier panel related to one embodiment of the present invention. Although the barrier panel 200B shown in FIG. 15 is similar to the barrier panel 200 shown in FIG. 2 or FIG. 8, the barrier panel 200B is different to the barrier panel 200 in that a first electrode 210B and second electrode 230B partially overlap.

As is shown in FIG. 15, the width of the first electrode 2108 is [a′] and the width of the second electrode 230B is [b′]. A width where an end part of the first electrode 210B and an end part of the second electrode 230B overlap is [g]. Here, in the case where the cross-section in FIG. 15 is viewed from an upper surface direction, that is, a planar view, the first electrode 210B and second electrode 230B overlap with each other.

As described above, according to the barrier panel related to the third embodiment, the first electrode 210B and second electrode 230B partially overlap in a planar view. Although an electric field can easily become weak with respect to liquid crystals in the vicinity of a boundary between an end part of the first electrode 210B and second electrode 230B, by adopting the structure described above, it is possible to increase stability of an electric field in the vicinity of a boundary between an end part of the first electrode 210B and second electrode 230B. In other words, controllability of liquid crystals is improved by the structure described above and stability of a barrier is improved.

### Fourth Embodiment

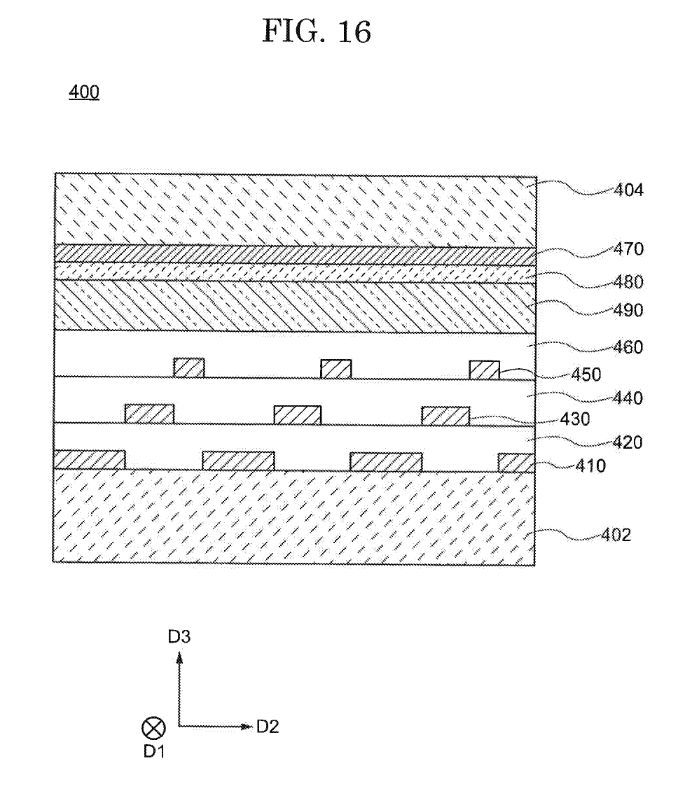

A structure of a barrier panel 400 related to a fourth embodiment of the present invention is explained using FIG. 16. FIG. 16 is a cross-sectional diagram showing a positional relationship between a first electrode, a second electrode and a third electrode for liquid crystal control (referred to herein as third electrode) of a barrier panel related to one embodiment of the present invention. Although the barrier panel 400 shown in FIG. 16 is similar to the barrier panel 200 shown in FIG. 2 or FIG. 8, the barrier panel 400 is different to the barrier panel 200 in that a third electrode 450 is included in addition to a first electrode 410 and second electrode 430.

### Structure of Barrier Panel 400

As is shown in FIG. 16, the barrier panel 400 includes a first substrate 402, a second substrate 404, a first electrode 410, a first insulation layer 420, a second electrode 430, a second insulation layer 440, a third electrode 450, a first alignment film 40, a common electrode 470, a second alignment film 480 and a liquid crystal layer 490. Here, the first substrate 402 and second substrate 404 oppose each other.

A plurality of first electrodes 410 is arranged above the first substrate 402. The insulation layer 420 is arranged above the first electrode 410 and covers an upper surface and side surface of the first electrode 410. A plurality of the second electrodes 430 is arranged above the first insulation layer 420. The second insulation layer 440 is arranged above the second electrode 430 and covers an upper surface and side surface of the second electrode 430. A plurality of third electrodes 450 is arranged above the second insulation layer 420. The first alignment film 460 is arranged above the third electrode 450 and covers an upper surface and side surface of the third electrode 450. The first electrode 410, second electrode 430 and third electrode 450 each extend in the first direction D1. The direction D1 is the same direction as the direction D1 shown in FIG. 3 and FIG. 6A for example. In the case that FIG. 16 is viewed from an upper surface direction, that is, a planar view, the third electrode 450 is arranged alternately with the first electrode 410 and second electrode 430.

The common electrode 470 is arranged above the second substrate 404. The common electrode 470 is arranged opposing the plurality of first electrodes 410, plurality of second electrodes 430 and plurality of third electrodes 450. The second alignment film 480 is arranged above the common electrode 470. The liquid crystal layer 490 is arranged between the first alignment film 460 and second alignment film 480.

The width of the second electrode 430 in a second direction D2 is smaller than the width of the first electrode 410 in the second direction D2. The width of the third electrode 450 in a second direction D2 is smaller than the width of the second electrode 430 in the second direction D2. Herein, the width of the first electrode 410 in the second direction D2 is simply referred to as the width of the first electrode 410, the width of the second electrode 430 in the second direction D2 is simply referred to as the width of the second electrode 430, and the width of the third electrode 450 in the second direction D2 is simply referred to as the width of the third electrode 450.

In other words, the liquid crystal layer 490 is arranged between the first substrate 402 and second substrate 404. The plurality of first electrodes 410 is arranged between the first substrate 402 and the liquid crystal layer 490. The plurality of second electrodes 430 is arranged between the plurality of first electrodes 410 and the liquid crystal layer 490. The plurality of third electrodes 450 is arranged between the plurality of second electrodes 430 and the liquid crystal layer 490. The first electrode 410 and second electrode 430 are insulated by the first insulation layer 420. The second electrode 430 and the third electrode 450 are insulated by the second insulation layer 440.

As described above, according to the barrier panel 400 related to the fourth embodiment, it is possible to obtain the same effects as the first embodiment, and it is possible to further widen an interval between adjacent first electrodes 410, an interval between adjacent second electrodes 430 and an interval between adjacent third electrodes 450 respectively. In this way, it is possible to suppress short circuits between adjacent electrodes even in the case where the first electrode 410, second electrode 430 and third electrode 450 are miniaturized.

### Modified Example of the Fourth Embodiment

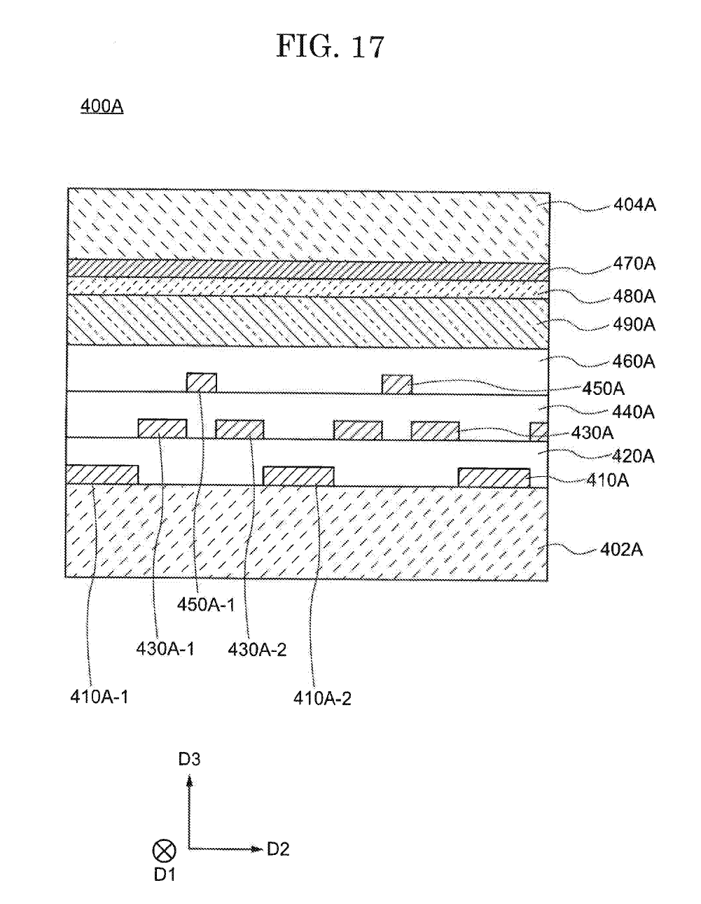

FIG. 17 is a cross-sectional diagram showing a positional relationship between a first electrode, a second electrode and a third electrode of a barrier panel related to a modified example of one embodiment of the present invention. Although the barrier panel 400A shown in FIG. 17 is similar to the barrier panel 400 shown in FIG. 16, the barrier panel 400A is different to the barrier panel 400 in that a second electrode 430A is arranged on both sides of the third electrode 450A.

As is shown in FIG. 17, when FIG. 17 is seen from an upper surface direction, that is, in a planar view, the first electrode 410A-1, second electrode 430A-1, third electrode 450A-1, second electrode 430A-2 and first electrode 410A-2 are arranged in order in the direction D2. In other words, the second electrode 430A is arranged on both sides of the third electrode 450A. In a planar view, the first electrode 410A is arranged on one side of the second electrode 430A and the third electrode 450A is arranged on the other side. In a planar view, the second electrode 430A is arranged on both sides of the first electrode 410A. The structure in FIG. 17 can also be described as the third electrode 450A in a planar view is alternately arranged with the first electrode 410A and second electrode 430A.

As described above, according to the barrier panel 400A related to a modified example of the fourth embodiment, it is possible to obtain the same effects as the fourth embodiment, and it is possible to further relax the difference in distance between each of the adjacent electrodes for liquid crystal control and a common electrode (that is, a step of adjacent electrodes for liquid crystal control in FIG. 17). As a result, it is possible to suppress alignment disorder of a liquid crystal layer at a position corresponding to a vicinity of a boundary between adjacent electrodes for liquid crystal control.

### Fifth Embodiment

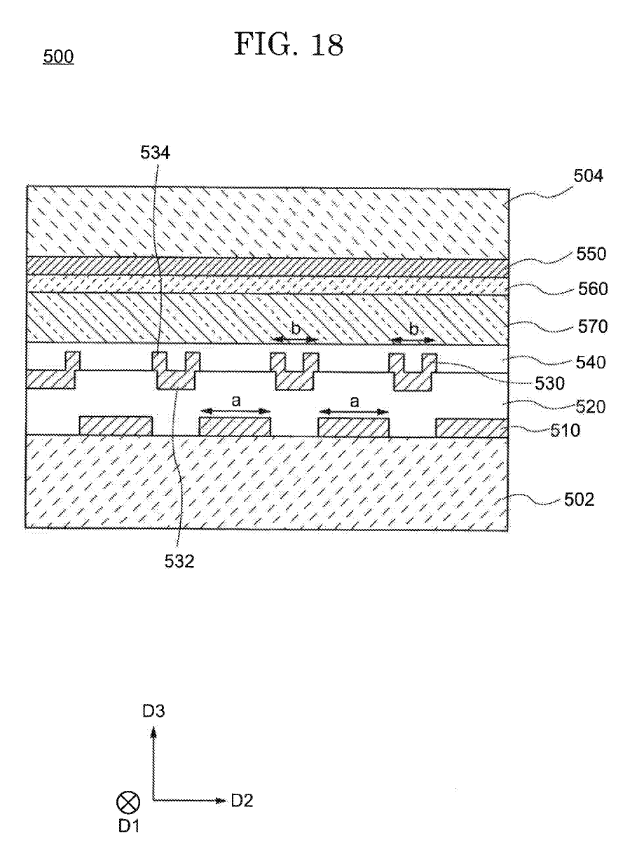

A structure of a barrier panel 500 related to a fifth embodiment of the present invention is explained using FIG. 18. FIG. 18 is a cross-sectional diagram showing a positional relationship between a first electrode and a second electrode of a barrier panel related to one embodiment of the present invention. Although the barrier panel 500 shown in FIG. 18 is similar to the barrier panel 200 shown in FIG. 2 or FIG. 8, the barrier panel 500 is different to the barrier panel 200 in a cross-sectional shape of the insulation layer 520 and second electrode 530.

### Structure of Barrier Panel 500

As is shown in FIG. 18, in the barrier panel 500, the insulation layer 520 includes a shape reflecting a step of a lower layer first electrode 510. That is, the insulation layer 520 in a region arranged with the first electrode 510 projects in the direction of the second substrate 504 compared to the insulation layer 520 in a region which is not arranged with the first electrode 510. In other words, a concave part is arranged in the insulation layer 520 in a region which is not arranged with the first electrode 510.

Both end parts 534 of the second electrode 530 in the second direction D2 are closer to a liquid crystal layer compared to a center part 532 in the direction D2. In other words, both end parts 534 are closer to a liquid crystal layer compared to a center part 532. Again in other words, both end parts 534 are arranged above the insulation layer 520 which projects upwards, and the center part 532 is arranged in the concave part of the insulation layer 520.

As described above, according to the barrier panel 500 related to the fifth embodiment, it is possible to obtain the same effects as the first embodiment, and since the distance between both end parts 534 of the second electrode 530 and the common electrode 550 becomes smaller compared to the distance between the center part 532 and the common electrode 550, controllability of the liquid crystal layer 570 in an end part of the second electrode 530 in the direction D2 is improved. As a result, it is possible to reduce the width [b] of the second electrode 530 and increase the distance between adjacent second electrodes 530.

### Modified Example of the Fifth Embodiment

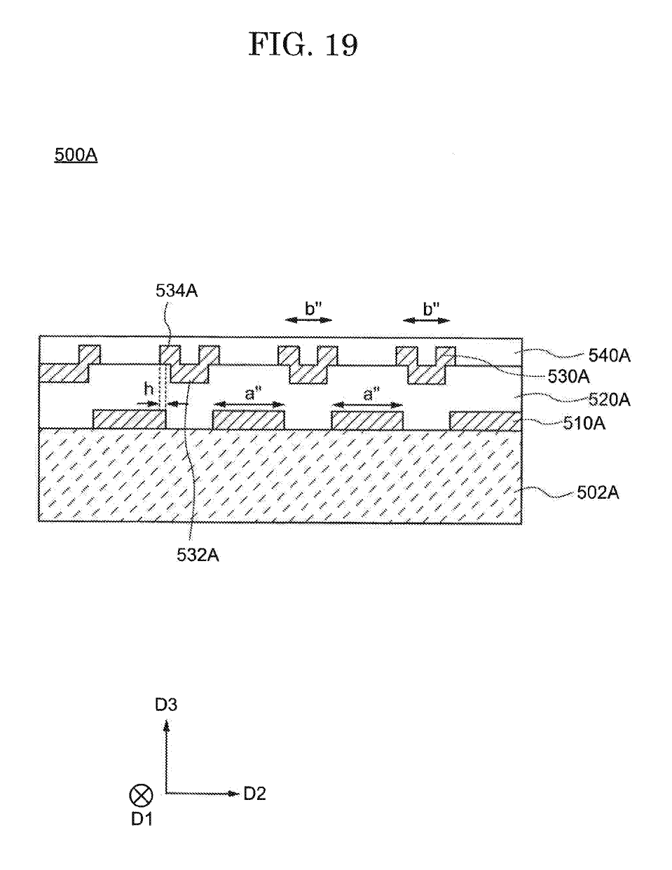

A structure of a barrier panel 500A related to a modified example of the fifth embodiment of the present invention is explained using FIG. 19. FIG. 19 is a cross-sectional diagram showing a positional relationship between a first electrode and a second electrode of a barrier panel related to a modified example of one embodiment of the present invention. Although the barrier panel 500A shown in FIG. 19 is similar to the barrier panel 500 shown in FIG. 18, the barrier panel 500A is different to the barrier panel 500 in that the first electrode 510A and second electrode 530A partially overlap.

As is shown in FIG. 19, the width of the first electrode 510A is [a″] and the width of the second electrode 530A is [b″]. The width where an end part of the first electrode 510A and an end part of the second electrode 530A overlap is [h]. Here, in the case where the cross-section in FIG. 19 is seen from an upper surface direction, that is, a planar view, the first electrode 510A and second electrode 530A overlap each other.

As described above, according to the barrier panel 500A related to a modified example of the fifth embodiment, when the first electrode 510A and second electrode 530A partially overlap in a planar view, it is possible to improve controllability of liquid crystals particularly at a position corresponding to a vicinity of a boundary between an part of the first electrode 510A and the second electrode 530A.

### Sixth Embodiment

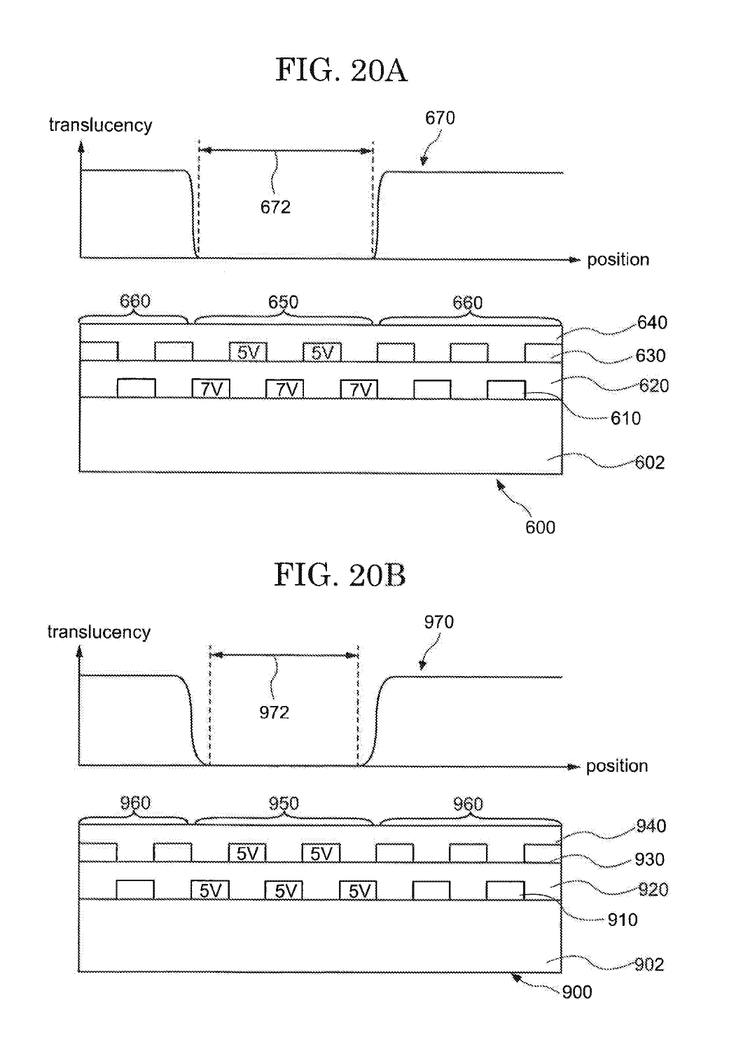

A structure of a barrier panel 600 related to a sixth embodiment of the present invention is explained using FIG. 20A. FIG. 20A is a schematic diagram showing a driving method of a barrier panel and barrier characteristics when the barrier panel is driven related to one embodiment of the present invention. In FIG. 20A, for convenience of explanation, in the barrier panel 600, only the first substrate 602, first electrode 610, insulation layer 620, second electrode 630 and first alignment film 640 are shown. However, the barrier panel 600 includes a second substrate, a common electrode and a liquid crystal layer the same as the barrier panel 200 shown in FIG. 2 or FIG. 8.

Although the barrier panel 600 shown in FIG. 20A is similar to the barrier panel 200 shown in FIG. 2 and FIG. 8, the barrier panel 600 is different to the barrier panel 200 in that the width of the first electrode 610 and the width of the second electrode 630 in the direction D2 are the same. The first substrate 602, first electrode 610, insulation layer 620, second electrode 630 and first alignment film 640 shown in FIG. 20A each correspond to the first substrate 202, first electrode 210, insulation layer 220, second electrode 230 and first alignment film 240 shown in FIG. 2 and FIG. 8.

As is shown in FIG. 20A, a light blocking region (barrier region 670) is formed in the first region 650 by supplying a first drive voltage (7V) to the first electrode 610 in the first region 650, and supplying a second drive voltage (5V) to the second electrode 630 in the first region 650. Since a drive voltage is not supplied to the first electrode 610 and second electrode 630 in the second region 660, a translucent region is formed in the second region 660. That is, a smaller drive voltage is supplied to the second electrode 630 than the first electrode 610. The spectrum 670 is barrier characteristics in the state described above, and expresses a relationship between the position of the first substrate 602 in the direction D2 and transparency of the barrier panel 600.

On the other hand, a barrier panel 900 is shown in FIG. 20B as a comparative example of the barrier panel 600 shown in FIG. 20A. FIG. 20B is a schematic diagram showing a driving method of a barrier panel and barrier characteristics when the barrier panel is driven related to a comparative example of the present invention. Since the structure of the barrier panel 900 in FIG. 20B is the same as the barrier panel 600 in FIG. 20A, an explanation is omitted here.

As is shown in FIG. 20B, a light blocking region (barrier region 972) is formed in the first region 950 by supplying the same drive voltage (5V) to the first electrode 910 and second electrode 930 in the first region 950. The spectrum 970 is barrier characteristics in the state described above, and expresses a relationship between the position of the first substrate 902 in the direction D2 and transparency of the barrier panel 900.

Comparing FIG. 20A and FIG. 20B, the spectrum 670 in FIG. 20A has a steep spectrum shape at an end part of the barrier region 672 in the direction D2 compared to the spectrum 970 in FIG. 20B. That is, as is shown in FIG. 20A, by supplying a higher drive voltage to the first electrode 610 than the second electrode 630, it is possible to suppress liquid crystal disorder at a position corresponding to an end part of the barrier region 672 in the direction D2.

As described above, according to the barrier panel related to the sixth embodiment, by supplying a smaller drive voltage to the second electrode 630 than the first electrode 610, it is possible to improve controllability of a barrier region.

### Modified Example of the Sixth Embodiment

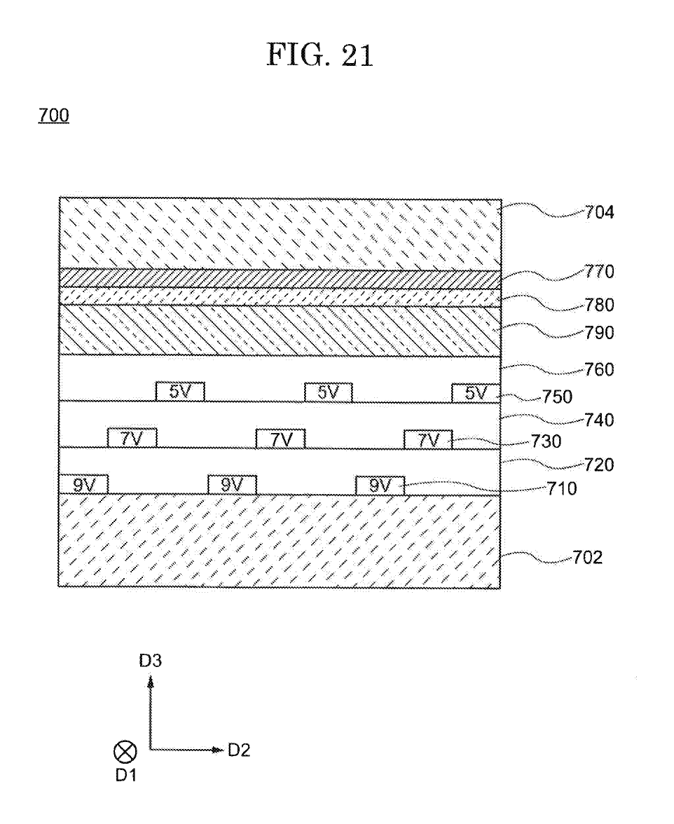

As is in the sixth embodiment described above, in an electrode for liquid crystal control formed by a plurality of layers, a barrier panel supplied with a high drive voltage to the extent of a lower layer electrode for liquid crystal control can be applied to the barrier panels shown in the second to fifth embodiments described above. For example, an example in which the barrier panel 600 shown in the sixth embodiment is applied to the barrier panel 400 shown in the fourth embodiment is shown in FIG. 21.

FIG. 21 is a schematic diagram showing a driving method of a barrier panel and barrier characteristics when the barrier panel is driven related to one embodiment of the present invention. Although the barrier panel 700 shown in FIG. 21 is similar to the barrier panel 400 shown in FIG. 16, the barrier panel 700 is different to the barrier panel 400 in that the width of the first electrode 710, width of the second electrode 730 and width of the third electrode 750 in the direction D2 are the same. The first substrate 702, second substrate 704, first electrode 710, first insulation layer 720, second electrode 730, second insulation layer 740, third electrode 750, first alignment film 760, common electrode 770, second alignment film 780 and liquid crystal layer 790 shown in FIG. 21 each correspond to the first substrate 402, second substrate 404, first electrode 410, first insulation layer 420, second electrode 430, second insulation layer 440, third electrode 450, first alignment film 460, common electrode 470, second alignment film 480 and liquid crystal layer 490 shown in FIG. 16. Furthermore, a state in which a drive voltage is supplied to all the electrodes for liquid crystal control is shown in FIG. 21.

As is shown in FIG. 21, a light blocking region is formed by supplying a first drive voltage (9V) to the first electrode 710, a second drive voltage (7V) to the second electrode 730 and a third drive voltage (5V) to the third electrode 750. In this way, the barrier panel 700 can improve controllability of a barrier region the same as the barrier panel 600 shown in FIG. 20A.

Furthermore, the present invention is not limited to the embodiments described above and may be appropriately modified within a scope that does not depart from the concept of the present invention.

What is claimed is:

1. A parallax barrier panel comprising:
a first substrate;
a second substrate opposing the first substrate;
a liquid crystal layer between the first substrate and the second substrate;
a plurality of first electrodes arranged between the first substrate and the liquid crystal layer, the plurality of first electrodes extending in a first direction;
a plurality of second electrodes arranged between the plurality of first electrodes and the liquid crystal layer, the plurality of second electrodes extending in the first direction and arranged alternating with the plurality of first electrodes in a plan view; and
an opposing electrode opposing the plurality of first electrodes and the plurality of second electrodes;
wherein
the second electrode is insulated from the first electrode, and a width of the second electrode in the second direction intersecting the first direction is smaller than a width of the first electrode in the second direction.

2. The parallax barrier panel according to claim 1, wherein the plurality of first electrodes and the plurality of second electrodes are each supplied with a different voltage respectively.

3. The parallax barrier panel according to claim 1, wherein a difference in a width of the first electrode in the second direction and a width of the second electrode in the second direction is 1.5 μm or more and 4.5 μm or less.

4. The parallax barrier panel according to claim 1, wherein the first electrode and the second electrode partially overlap in a planar view.

5. The parallax barrier panel according to claim 1, wherein both ends of the second electrode in the second direction are closer to the liquid crystal layer compared to a center section of the second electrode in the second direction.

6. The parallax barrier panel according to claim 1, further comprising:
a plurality of third electrodes arranged between the plurality of second electrodes and the liquid crystal layer, the plurality of third electrodes extending in the first direction and arranged alternating with the plurality of first electrodes and the plurality of second electrodes in a plan view;
wherein
the third electrode is insulated from the second electrode, and a width of the third electrode in the second direction is smaller than a width of the second electrode in the second direction.

7. A parallax barrier panel comprising:
a first substrate;
a second substrate opposing the first substrate;
a liquid crystal layer between the first substrate and the second substrate;
a plurality of first electrodes arranged between the first substrate and the liquid crystal layer, the plurality of first electrodes extending in a first direction;
a plurality of second electrodes arranged between the plurality of first electrodes and the liquid crystal layer, the plurality of second electrodes extending in the first direction and arranged alternating with the plurality of first electrodes in a planar view; and
an opposing electrode opposing the plurality of first electrodes and the plurality of second electrodes;
wherein
the second electrode is insulated from the first electrode, and is supplied with a smaller voltage than the first electrode.

8. The parallax barrier panel according to claim 7, wherein the first electrode and the second electrode partially overlap in a planar view.

9. The parallax barrier panel according to claim 7, wherein both ends of the second electrode in the second direction intersecting the first direction are closer to the liquid crystal layer compared to a center section of the second electrode in the second direction.

10. The parallax barrier panel according to claim 7, further comprising:
a plurality of third electrodes arranged between the plurality of second electrodes and the liquid crystal layer, the plurality of third electrodes extending in the first direction and arranged alternating with the plurality of first electrodes and the plurality of second electrodes in a plan view;
wherein
the third electrode is insulated from the second electrode, and is supplied with a smaller voltage than the second electrode.

11. The parallax barrier panel according to claim 1, wherein a long axis of a liquid crystal molecule included in the liquid crystal layer is arranged in a perpendicular direction to the first substrate when a driving voltage is applied, and a total of the number of adjacent first electrodes applied with the driving voltage among the plurality of first electrodes and adjacent second electrodes applied with the driving voltage among the plurality of second electrodes is an even number in the case of forming a parallax barrier.

12. The parallax barrier panel according to claim 11, wherein the even number is 4 or more.

13. A display device using a parallax barrier panel comprising:
the parallax barrier panel according to claim 1; and
a display panel arranged opposing the parallax barrier panel, the display panel including a plurality of pixels.

14. The parallax barrier panel according to claim 2, wherein a difference in a width of the first electrode in the second direction and a width of the second electrode in the second direction is 1.5 μm or more and 4.5 μm or less.

15. The parallax barrier panel according to claim 2, wherein the first electrode and the second electrode partially overlap in a planar view.

16. The parallax barrier panel according to claim 3, wherein the first electrode and the second electrode partially overlap in a planar view.

17. The parallax barrier panel according to claim 8, wherein both ends of the second electrode in the second direction intersecting the first direction are closer to the liquid crystal layer compared to a center section of the second electrode in the second direction.

18. The parallax barrier panel according to claim 8, further comprising:
a plurality of third electrodes arranged between the plurality of second electrodes and the liquid crystal layer, the plurality of third electrodes extending in the first direction and arranged alternating with the plurality of first electrodes and the plurality of second electrodes in a plan view;
wherein
the third electrode is insulated from the second electrode, and is supplied with a smaller voltage than the second electrode.

19. The parallax barrier panel according to claim 9, further comprising:
a plurality of third electrodes arranged between the plurality of second electrodes and the liquid crystal layer, the plurality of third electrodes extending in the first direction and arranged alternating with the plurality of first electrodes and the plurality of second electrodes in a plan view;
wherein
the third electrode is insulated from the second electrode, and is supplied with a smaller voltage than the second electrode.

20. The parallax barrier panel according to claim 7, wherein a long axis of a liquid crystal molecule included in the liquid crystal layer is arranged in a perpendicular direction to the first substrate when a driving voltage is applied, and a total of the number of adjacent first electrodes applied with the driving voltage among the plurality of first electrodes and adjacent second electrodes applied with the driving voltage among the plurality of second electrodes is an even number in the case of forming a parallax barrier.
